(19) United States
(12) Patent Application Publication
(10) Pub. No.: US 2009/0216545 A1
(43) Pub. Date: Aug. 27, 2009

(54) CONTRACT AUTHORING TEMPLATE CREATION

(75) Inventors: Vijayanand Rajkumar, Redwood City, CA (US); Rhonda Stieber, Los Altos, CA (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/035,097

(22) Filed: Feb. 21, 2008

(51) Int. Cl. G06Q 10/00

(52) U.S. Cl. 705/1

(57) ABSTRACT

A system allows a contract administrator to define the attributes of a contract template, and then generate a user interface. The contract administrator can modify the contract template user interface attributes, and the system then creates and stores a modified contract template. The modified contract template is subsequently rendered into a modified deal sheet user interface that is used by an end user to author a contract.

### FIELD OF THE INVENTION

One embodiment is directed generally to document processing, and in particular to contract authoring.

### BACKGROUND INFORMATION

Authoring complex contracts is a very involved process requiring significant investment of time and resources. Businesses need to draft many different types of contracts to run the business. For example, some contracts are authored for sales to customers, including one-time sales and long term agreements that govern discounts or volume commitments. Other examples of contracts include purchasing agreements, marketing or non-disclosure agreements, rental agreements, service contracts, etc. These different types of contracts all require different information in order to author the contract. In the case of a sales agreement, a drafter of the contract would need to know the products and discounts that have been agreed upon. In a service contract, a drafter of the contract may need to include the conditions of coverage. In all cases, it is important for a business to be able to ensure that the contractual terms and conditions are consistent with corporate standards and will protect the company from undue risk. In addition, it is important to be able to produce contracts quickly, while still ensuring that the contract is accurate and per standards. In a sales cycle, a quick turn around on the contract document may make a big difference in closing the deal.

Even with known automated tools, contract authoring can be a very tedious process for multiple reasons. For one, information that needs to be captured to author a contract includes terms that are specific to the type of contract being authored. A sales contract requires different terms than a marketing agreement. For example, for a sales contract, this information may include the products and prices being negotiated, ship to and bill to locations, revenue recognition rules, etc. Each type of contract may have different information that defines the terms of that type of contract.

Further, the type of business terms that needs to be captured varies widely by industry. For example, a company selling project based work would negotiate a completely different set of information than a company selling simple widgets. As a result, known automated tools are generally focused on a specific type of contract and can only automate a small subset of the required functionality, and known products that attempt to automate the entire lifecycle of a contract (i.e., creation of a contract and execution of a contract) tend to be specialized for a specific industry. Therefore, any generic contract authoring solution that can handle all types contracts becomes complex and unwieldy for a typical user when authoring contracts because the user interface cannot be tailored for a specific type of contract or industry or user role.

Because of these problems, many users continue to use custom spreadsheets or word processing documents to enter the initial contract quickly, and later transfer that information into a contracts application via data re-entry or custom import/integration. However, this can lead to costly human errors.

### SUMMARY OF THE INVENTION

One embodiment is a system that allows a contract administrator to define the attributes of a contract template, and then generate a user interface. The contract administrator can modify the contract template user interface attributes, and the system then creates and stores a modified contract template. The modified contract template is subsequently rendered into a modified deal sheet user interface that is used by an end user to author a contract.

### BRIEF DESCRIPTION OF THE DRAWINGS

FIG. 1 is a block diagram of a system or computer that can implement an embodiment of the present invention.

FIG. 2 illustrates a designer template user interface that can be used to create a template in accordance with one embodiment.

FIG. 3 illustrates a designer template user interface that can be used to create a template in accordance with one embodiment.

FIG. 4 illustrates a user interface in accordance with one embodiment that illustrates some of the actions available in order to customize a contract template.

FIG. 5 illustrates a user interface in accordance with one embodiment that illustrates the action for the “Add Tab/Wizard step”.

FIG. 6 illustrates a user interface in accordance with one embodiment that illustrates the action for the “Add from Data Catalog”.

FIG. 7 illustrates a user interface in accordance with one embodiment that illustrates the action for the “Preview Form”.

FIG. 8 is a flow diagram of the functionality of the system in accordance with one embodiment when creating a contract template/deal sheet that can be used for authoring a contract.

FIG. 9 is a flow diagram of the functionality of the system in accordance with one embodiment when authoring a contract using one of the templates/deal sheets that was created in FIG. 8.

### DETAILED DESCRIPTION

One embodiment is a contract management system that automates the entire lifecycle of a contract by providing tools to author the contract, and ensuring that all contractual obligations are met by integrating with appropriate execution systems. Embodiments allow a contract administrator to create multiple specialized user interface templates, also referred to as contract templates, or “deal sheet” templates, for many different types of contracts. A template may be based on the type of contract being authored, or be tailored for a particular user role. The system generates a contract template designer user interface that provides the ability to create and modify these templates. The template comprises a plurality of attributes organized in a predetermined and tailored way. The contract administrator may choose to create a template or modify an existing template. Modifying a template involves changing what attributes are included in the template and how they are organized. The contract administrator can include all the attributes that define a certain type of contractual arrangement or a subset of them and organize them in the most logical way. When the template is used for authoring by an end user, the system renders a user interface based on the template to the end user. The user interface rendered to an end user based on the template can be referred to as a “deal sheet”.

Many different types of contracts are frequently needed to be created by organizations. For example, sell-side contracts may include contracts for selling products (e.g., inventory-based products), services (e.g., warranties), projects (e.g., construction), etc. Other types of contracts may be needed to be created when purchasing products and services. Further, specialized contracts may need to be created for leases, loans, intellectual property acquisition, etc. When authoring contracts, different types of contracts likely require different types of information to be captured. A generic contract authoring tool cannot easily accommodate creation of these different types of contracts in a simple user friendly manner.

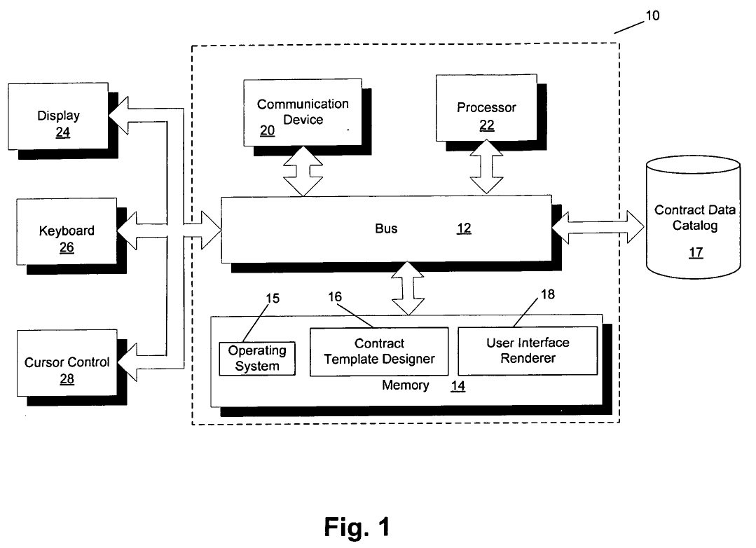

FIG. 1 is a block diagram of a system or computer 10 that can implement an embodiment of the present invention. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as network interface card, to provide access to a network.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

System 10 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores an operating system 15 and a contract template designer 16 and a user interface renderer 18. Contract template designer 16, when executed by processor 22, performs the functionality of designing/creating a specialized contract template, while user interface renderer 18 then renders the appropriate user interface or deal sheet, as disclosed below. In another embodiment, communication device 20 is coupled to the Internet or other network, and system 10 executes an Internet browser, such as the Internet Explorer from Microsoft Corp., and executes a web-based software application via the browser and via an Internet web server that transmits and receives data over the Internet. In this embodiment, contract template designer 16 and user interface renderer 18 is located and executed on the web server and displayed on system 10 via the browser. Contract template designer 16 and user interface renderer 18 can also be located on a server and accessed via a client in any other client/server arrangement. In this embodiment, the client communicates with the server which is coupled to the contract data catalog and contract template database.

System 10 is further coupled to a contract data catalog database 17 that in one embodiment stores attributes that are needed to author a contract. The attributes may include customer specific attributes defined during implementation (“user-defined attributes”). The attributes may be singular, multi-valued or a table of records. Examples of attributes include the contract start date (a singular attribute), the contract parties (a multi-valued attribute), and the contract lines (the contract products and prices—a table of records attribute). Attributes could also include user defined questions such as “Is this a government customer?”, “Is an audit required”, etc. Database 17 further stores contract templates that have been customized by a user in the designer tool, and that can be later used to author a contract by an end user. Database 17 can be any type of database, and in one embodiment is part of an Enterprise Resource Planning (“ERP”) system.

Contract catalog database 17 further stores contract templates that can be specific based on the type of contract (e.g., sales of services, purchasing of goods). These templates, through contract template designer 16 and user interface renderer 18, can be retrieved and customized by a user at system 10.

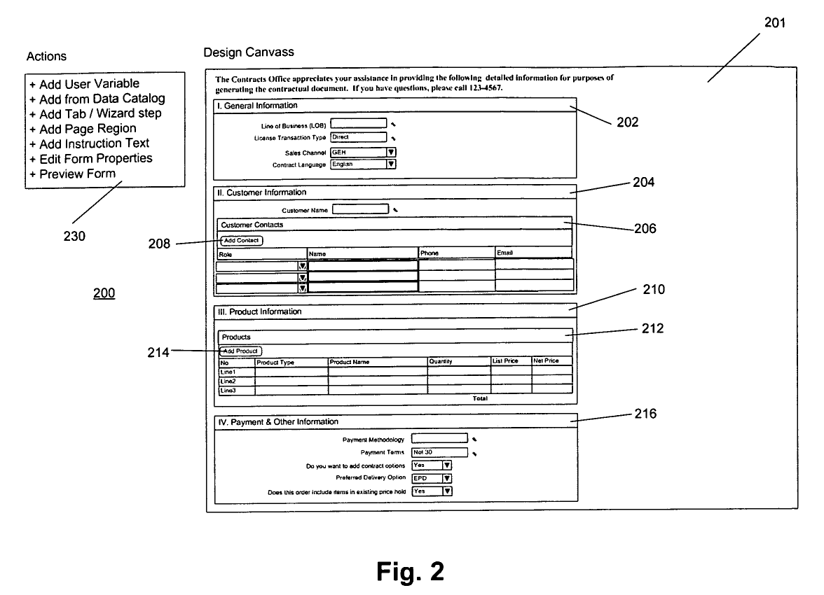

FIG. 2 illustrates a designer user interface (“UI”) UI 200 that can be used to create a template in accordance with one embodiment. In the example of FIG. 2, template 201 is customized/designed to allow a user to create a sales contract, and includes multiple regions that receive business terms input from a user when preparing the contract. General information region 202 receives general information regarding the contract. Customer information region 204 receives information about the customer that is purchasing the product, including customer contacts that can be added through an add contact button 208. Product information region 210 receives information about the products, and additional products can be added through an add product button 214. Payment and other information region 216 receives the financial information about the contract. The regions shown in FIG. 2 include examples of some of the attributes that a user could retrieve from contract data catalog 17 in order to create a template. In other embodiments, different attributes would be retrieved and modified depending on the user's need and the type of contract that ultimately needs to be authored.

Template 201, as shown in FIG. 2, was created in one embodiment through user interaction with a designer action box 230 in order to modify and customize template 200 by adding or deleting contract attributes. Action box 230 includes customization options available to a user in one embodiment, including add user variable, add from data catalog, add tab/wizard step, add page region, add instruction text, edit form properties, and preview form. In other embodiments, the options of actions box 230 may differ from those shown in FIG. 2.

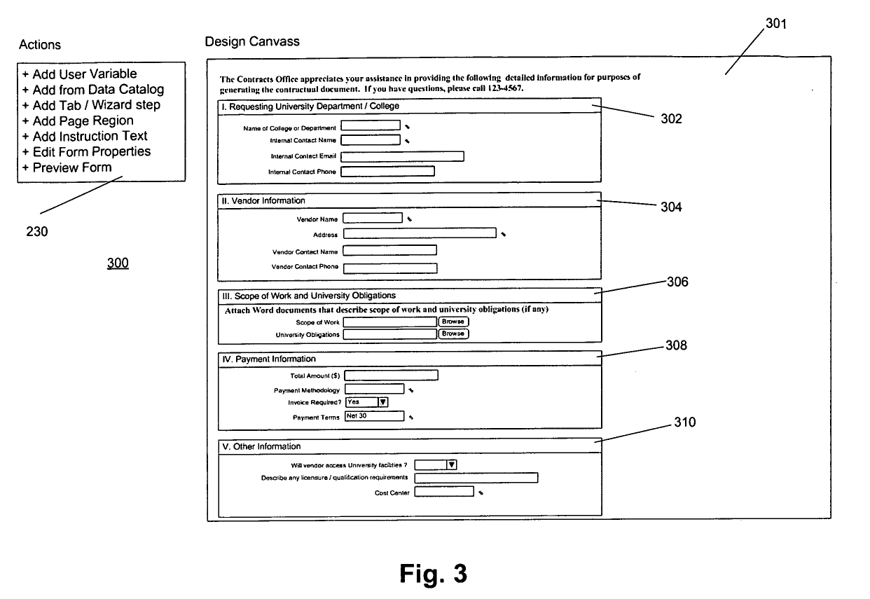

FIG. 3 illustrates a designer UI 300 that can be used to create a template in accordance with one embodiment. In the example of FIG. 3, template 301 is customized for a purchasing contract of a service by a university department, and includes multiple regions that receive input from a user when preparing the contract. Template 301 includes a requesting region 302 for receiving information regarding the requesting university department/college and a vendor region 304 for receiving information on the vendor. Scope of work region 306 is used to receive information about the scope of the service that the vendor will provide. Payment region 308 receives payment information and other information region 310 receives other information. Template 301 further includes action box 230.

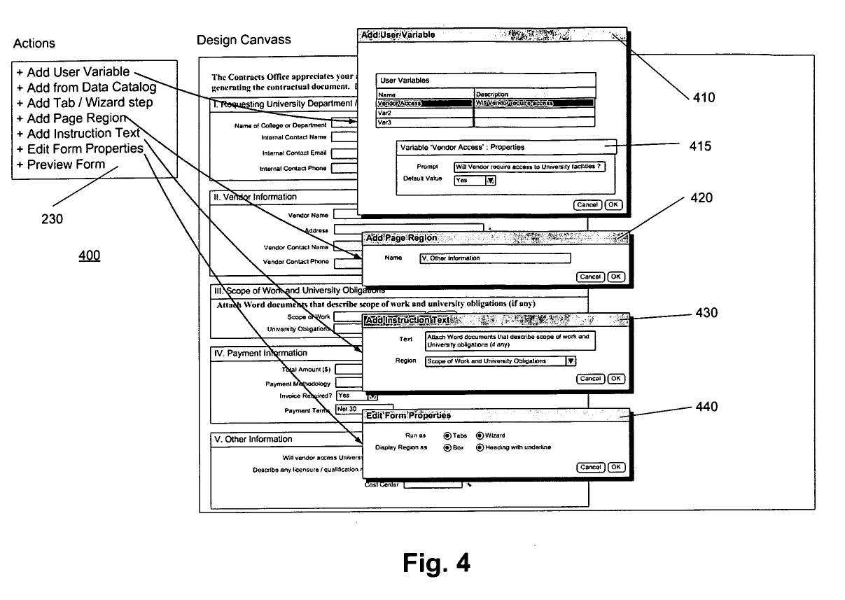

FIG. 4 illustrates a UI 400 in accordance with one embodiment that illustrates some of the actions available in action box 230 in order to customize a contract template by modifying some of the attributes in the regions or taking other actions. In one embodiment, boxes pop up when a user selects one of the options of action box 230. The user can interface with the boxes to modify the contract templates. For example, as shown, when “Add User Variable” is selected, box 410 pops up. Box 410 allows a user to add variables to the contract template. When one of the user variables is selected, such as the “vendor access” variable, a properties box 415 opens that allows properties of that variable to be defined, which controls how it appears to the user using the template. Properties can include specifying a prompt (e.g., “Will Vendor require access to University Facility?”) and specifying a default value that will be displayed when the deal sheet based on this template is rendered (e.g., default value of “yes”). This added variable is shown in region 310 of template 301 of FIG. 3.

When “Add Page Region” is selected, box 420 pops up which allows a user to add another region to the contract template. In box 420, region “V. Other Information”, is added. This added region is shown as region 310 of FIG. 3.

When “Add Instruction Text” is selected, box 430 pops up and the text of an instruction and the region in which the instruction should be inserted can be entered. In box 430, the “Attach Word documents that describe scope of work and university obligations (if any)” instruction is added to region 306 of template 301 of FIG. 3.

When “Edit Form Properties” is selected, box 440 pops up allowing properties of the contract template to be changed. In one embodiment, the various regions that form the template can be presented to the user when authoring a contract in a single page (as in FIGS. 2 and 3) or can be individually presented to the user as separate tabs or in the form of a wizard that that asks for information in multiple pages in a particular sequence. Further, the various region headers of the contract template can be displayed in different ways, such as in a box and/or as a heading with underline. Other properties can also be defined in box 440.

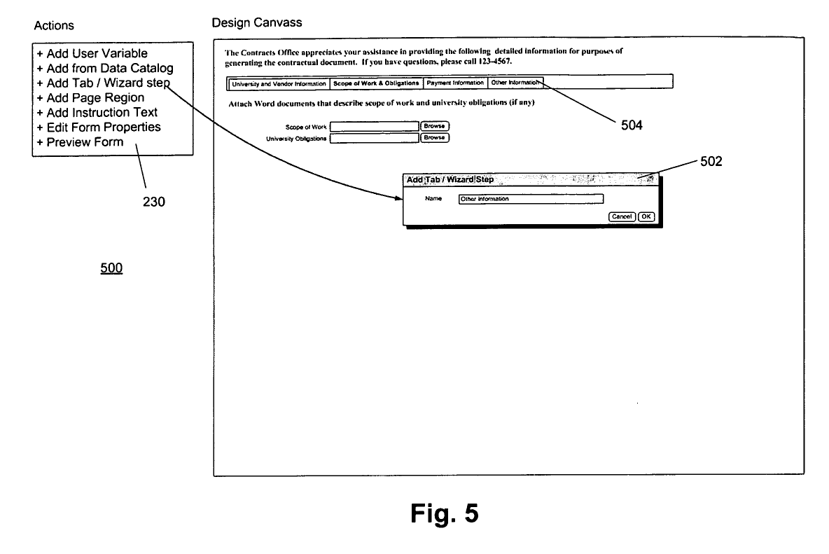

FIG. 5 illustrates a UI 500 in accordance with one embodiment that illustrates the action for the “Add Tab/Wizard step” from action box 230. Upon selection of the “Add Tab/Wizard step”, box 502 pops up which allows tab or wizard step to be added in an implementation where the contract template will be filled out using separate tabs or a forms wizard. In the example of FIG. 5, an “Other Information Tab” is added in box 502, which results in tab 504.

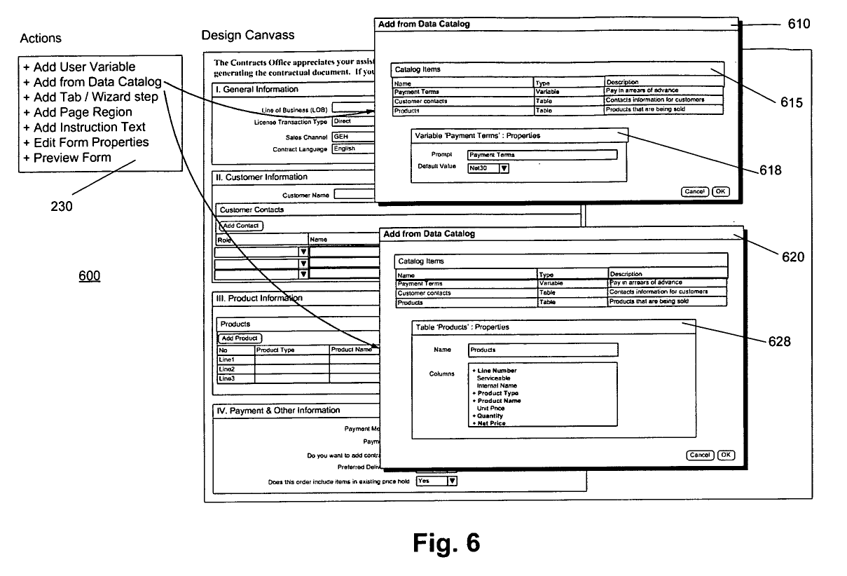

FIG. 6 illustrates a UI 600 in accordance with one embodiment that illustrates the action for the “Add from Data Catalog” from action box 230. Upon selection of “Add from Data Catalog”, box 615 (or box 620 in another example) pops up, which allows a user to select an attribute from contract catalog data database 17 of FIG. 1. A catalog items table 615 list all items that can be selected and added to one of the regions of the contract template. When an item is selected in 615, a box 618 allows certain properties about that item to be defined. Therefore, as shown in box 615, for the “Payment Terms” item (which is a single valued variable), the prompt (as it is intended to appear in the template) can be defined, and the default value can also be defined. The “Payment Terms” item in this example is shown in region 216 of FIG. 2. In box 620, the selection of the “Products” item (a table type variable) allows properties for that table variable to be defined in box 628, including the table columns that should appear when this variable is included in the template. The “Products” item in this example is shown in region 210 of FIG. 2 as table 212.

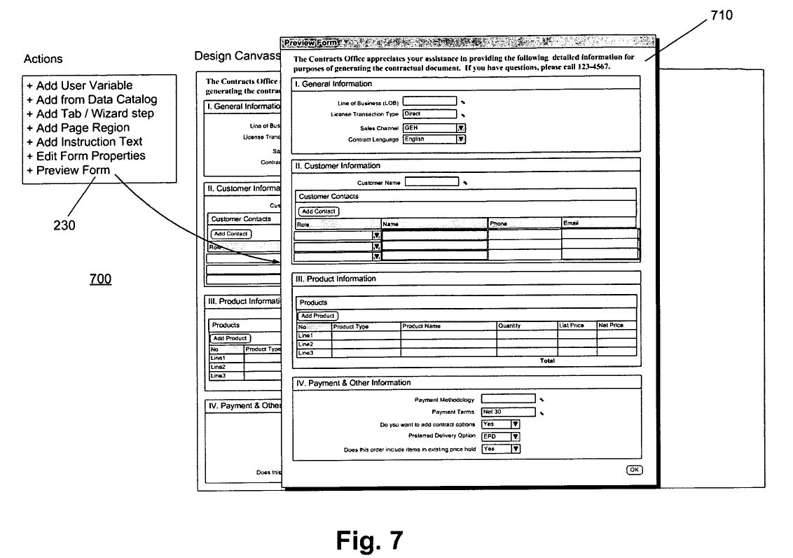

FIG. 7 illustrates a UI 700 in accordance with one embodiment that illustrates the action for the “Preview Form” from action box 230. This action uses user interface renderer 18 to display the template that was designed by the user exactly as it would appear for an end user who is authoring a contract using this template. As shown, a box 710 pops up that displays the template.

When a contract template is created using contract template designer 16 through interaction of the UIs shown, for example, in FIGS. 2-7, the template may be saved in database 17. Subsequently, user interface renderer 18 may retrieve the template and display the template to an end user to input the required information in order to author the contract. The type of template that is rendered to the end user may be determined automatically by the system based on various factors such as the type of contract being authored (e.g., sales, purchase, etc.), the role of the user, etc.

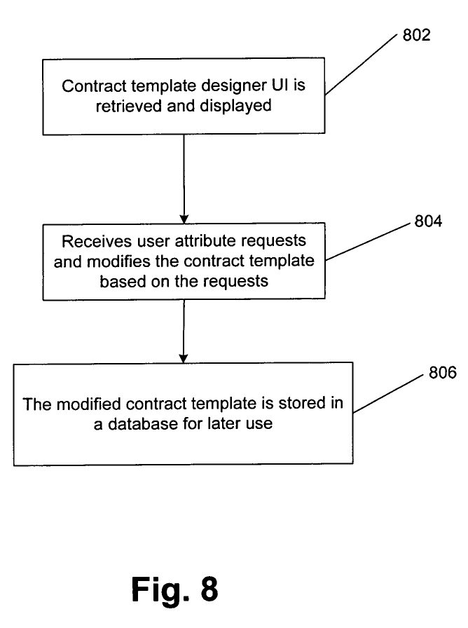

FIG. 8 is a flow diagram of the functionality of system 10 in accordance with one embodiment when creating a contract/deal sheet template that can be used for authoring a contract. In one embodiment, the functionality of the flow diagram of FIG. 8 is implemented by software stored in memory and executed by a processor. In other embodiments, the functionality can be performed by hardware, or any combination of hardware and software.

At 802, the contract administrator logs onto the template designer application and a previously created contract template designer UI, such as UI 200 of FIG. 2, is retrieved to be modified, or a new design is created. In one embodiment, the contract template designer UI is retrieved from database 17 and displayed through an Internet browser to a user at a client computer. The contract template designer UI includes user actions through action box 230 that allow attributes of the contract template to be customized for a specific type of contract.

At 804, system 10 receives user attribute requests from the contract administrator and modifies the contract template accordingly. The attribute requests are generated by the contract administrator through various actions in the designer tool, such as the actions shown in action box 230. The attributes include the addition or modification of user variables and regions, and attributes available from data catalog 17.

At 806, the modified contract template is stored in data catalog 17 for later use in order to create the contract.

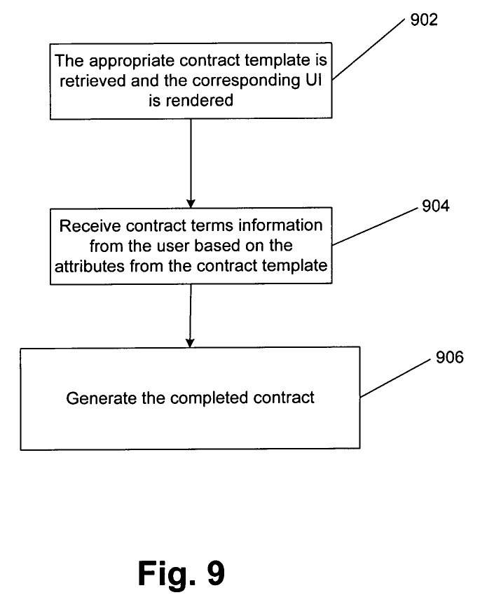

FIG. 9 is a flow diagram of the functionality of system 10 in accordance with one embodiment when authoring a contract using one of the templates that was created in FIG. 8. In one embodiment, the functionality of the flow diagram of FIG. 9 is implemented by software stored in memory and executed by a processor. In other embodiments, the functionality can be performed by hardware, or any combination of hardware and software.

At 902, the user logs into the system in order to author the contract. The system then retrieves the appropriate contract template for the user, and user interface renderer 18 displays the corresponding deal sheet user interface to the user. The selection of the appropriate contract template can be based on many factors, including the role of the user, the intended parties to the contract, the type of contract desired, etc.

At 904, the user enters the information that is requested by the user interface based on the attributes displayed. Because the user interface is tailored specifically to the desired type of contract, the required contract terms information for that type of contract will be entered by the user as guided by the attributes of the template. The user may interact with the user interface through a single page or through multiple pages in a particular sequence with a forms wizard, or through the selection of tabs. In one embodiment, the user interface is rendered as an Hypertext Markup Language (“HTML”) UI. In other embodiments, the user interface is rendered as an Excel worksheet, Word document, or other application compatible format.

At 906, the contract is generated based on the user input to the user interface. In one embodiment, the contract, because it was created through system 10, is linked to other modules of an integrated system such as an ERP so that the terms and conditions of the contract can be executed in future transactions.

As disclosed, the template designer tool in one embodiment allows a customized contract template to be created and later used to render a deal sheet UI for authoring a contract. Therefore, the authoring process is customized for any number of specialized contract types.

Several embodiments are specifically illustrated and/or described herein. However, it will be appreciated that modifications and variations of are covered by the above teachings and within the purview of the appended claims without departing from the spirit and intended scope of the invention.

1. A computer readable media having instructions stored thereon that, when executed by a processor, causes the processor to author a contract by:
generating a contract template designer user interface that comprises a plurality of attributes;
receiving a request to modify one or more of the attributes; and
creating a modified contract template based on the request.

2. The computer readable media of claim 1, further comprising:
rendering a user interface that corresponds to the modified contract template;
receiving input information for the one or more attributes; and
generating a contract based on the input information.

3. The computer readable media of claim 1, wherein the attributes comprise user defined questions.

4. The computer readable media of claim 1, wherein the attributes comprise input regions for entering terms and conditions of the contract.

5. The computer readable media of claim 3, wherein the request to modify comprises adding a user variable to the contract template.

6. The computer readable media of claim 1, wherein the request to modify comprises adding instruction text to the contract template.

7. The computer readable media of claim 1, wherein the request to modify comprises adding a first contract attribute to the contract template.

8. The computer readable media of claim 7, wherein the first contract attribute comprises at least one of payment terms, customer contacts, or products.

9. A method of authoring a contract comprising:
generating a contract template designer user interface that comprises a plurality of attributes;
receiving a request to modify one or more of the attributes; and
creating a modified contract template based on the request;
rendering a user interface that corresponds to the modified contract template;
receiving input information for the one or more attributes;
generating a contract based on the input information; and
linking the one or more attributes and the input information to an integrated system.

10. The method of claim 9, wherein the integrated system is an Enterprise Resource Planning system.

11. A system for authoring a contract comprising:
means for generating a contract template designer user interface that comprises a plurality of attributes;
means for receiving a request to modify one or more of the attributes; and
means for creating a modified contract template based on the request.

12. The system of claim 11, further comprising:
means for rendering a user interface that corresponds to the modified contract template;
means receiving input information for the one or more attributes; and
means for generating a contract based on the input information.

13. A system for authoring a contract comprising:
a processor;
a memory coupled to the processor, said memory comprising a contract template designer;
wherein the contract template designer, when executed by the processor, generates a contract template designer user interface that comprises a plurality of attributes, receives a request to modify one or more of the attributes, and creates a modified contract template based on the request.

14. The system of claim 13, wherein the memory further comprises a user interface renderer;
wherein the user interface renderer, when executed by the processor, renders a user interface that corresponds to the modified contract template, receives input information for the one or more attributes, and generates a contract based on the input information.
